(19) United States
(12) Patent Application Publication
(10) Pub. No.: US 2008/0168917 A1
(43) Pub. Date: Jul. 17, 2008

(54) Ink valve

(76) Inventor: Michael McCarty, Harrisonville, MO (US)

Correspondence Address: AVERILL & VARN, 8244 PAINTER AVE., WHITTIER, CA, 90602, US

(21) Appl. No.: 11/653,722

(22) Filed: Jan. 12, 2007

(51) Int. Cl. B41F 1/46

(52) U.S. Cl. 101/363

(57) ABSTRACT

A valve assembly includes a digitally controlled piston residing in a cylinder interior of a cylinder, and provides a linear flow rate versus piston position. Ink is pumped into a housing interior containing the cylinder. The ink flows from the housing interior into the cylinder interior through a tapered orifice in the cylinder, then from the cylinder interior to a printing press. The tapered orifice is aligned with the direction of travel of the piston and the position of the piston in the valve body is controlled by a stepper motor to determine how much of the tapered orifice is uncovered by the piston. The tapered orifice is designed to compensate for a pressure drop in the housing interior as the valve assembly opens to allow more flow, and results in the linear relationship between the piston position and the flow rate through the orifice.

### BACKGROUND OF THE INVENTION

The present invention relates to valves and in particular to an ink valve for a printing press, the ink valve providing a linear relationship between a valve position and an ink flow through the valve.

Printing presses require a controlled flow of ink based on varying speeds of the printing press, and what is being printed. Known valves used to control the flow of ink open and close an arbitrary orifice, and generally, the amount of opening of the orifice is linearly related to the degree of actuation of the valve. Unfortunately, as the valve is opened and the flow through the valve increases, a pressure drop in the source of the ink flow results in a less than linear flow rate through the valve. Further, as computers and software become commonly used to control the flow of ink, the non-linear flow characteristics of known valves result in requirements for complicated software and introduce sources of error into the control of the ink flow.

Further, known valves include a large number of moving parts, and these moving parts continue to move even after a printing press has reached a constant operating speed. As a result, parts often wear out or prematurely fail.

### BRIEF SUMMARY OF THE INVENTION

The present invention addresses the above and other needs by providing a valve assembly including a digitally controlled piston residing in a cylinder interior of a cylinder, and provides a linear flow rate versus piston position. Ink is pumped into a housing interior containing the cylinder. The ink flows from the housing interior into the cylinder interior through a tapered orifice in the cylinder, then from the cylinder interior to a printing press. The tapered orifice is aligned with the direction of travel of the piston and the position of the piston in the valve body is controlled by a stepper motor to determine how much of the tapered orifice is uncovered by the piston. The tapered orifice is designed to compensate for a pressure drop in the housing interior as the valve assembly opens to allow more flow, and results in the linear relationship between the piston position and the flow rate through the orifice. The piston is precisely linearly or angularly positioned in the valve body by a stepper motor to control how much of the orifice is uncovered and thereby control the flow rate of ink through the valve assembly. The stepper motor is controlled by computers and software developed to make very precise changes to the position of the piston so as to supply the correct amount of ink to a printing press for the different printing requirements.

In accordance with one aspect of the invention, there is provided a printing press inker assembly comprising a pump, a stepper motor, and an inker assembly housing containing a cylinder and a piston for regulating flow. A first ink line provides an inflow of ink to the pump and inker assembly housing receives the inflow of ink from the pump. The cylinder has a first cylinder end and a second cylinder end opposite the first cylinder end, wherein the cylinder interior is in fluid communication with a second ink line through the second cylinder end. Two tapered orifices reside in opposite sides of the cylinder and provide fluid communication between the housing interior and the cylinder interior, the orifices having a narrow end pointed toward the second cylinder end. The piston slidably resides in the cylinder interior and is linearly actuable through the first cylinder end, wherein the piston is slidable to adjust an overlap of the piston with the tapered orifices to regulate a flow through the orifices into the cylinder interior to provide a regulated outflow.

### BRIEF DESCRIPTION OF THE SEVERAL VIEWS OF THE DRAWING

The above and other aspects, features and advantages of the present invention will be more apparent from the following more particular description thereof, presented in conjunction with the following drawings wherein:

FIG. 1 is a digital newspaper press inker assembly according to the present invention.

FIG. 2 is a cross-sectional view of one valve assembly according to the present invention of the digital newspaper press inker assembly taken along line 2-2 of FIG. 1.

FIG. 3A shows the valve assembly in a partially open state.

FIG. 3B shows the valve assembly in a fully open state.

FIG. 3C shows the valve assembly in a nearly closed state.

FIG. 4A is a side view of a valve cylinder according to the present invention of the valve assembly.

FIG. 4B is a cross-sectional view of the valve cylinder according to the present invention of the valve assembly taken along line 4B-4B of FIG. 4A.

FIG. 5 is a detailed view of a tapered orifice according to the present invention.

FIG. 6A is a side view of a valve piston according to the present invention of the valve assembly.

FIG. 6B is an end view of the valve piston according to the present invention of the valve assembly.

FIG. 7 is a valve cylinder for a rotationally actuated piston.

FIG. 8A is an end view of the rotationally actuated piston.

FIG. 8B is a side view of the rotationally actuated piston.

FIG. 9 shows the rotationally actuated piston in the valve cylinder.

Corresponding reference characters indicate corresponding components throughout the several views of the drawings.

### DETAILED DESCRIPTION OF THE INVENTION

The following description is of the best mode presently contemplated for carrying out the invention. This description is not to be taken in a limiting sense, but is made merely for the purpose of describing one or more preferred embodiments of the invention. The scope of the invention should be determined with reference to the claims.

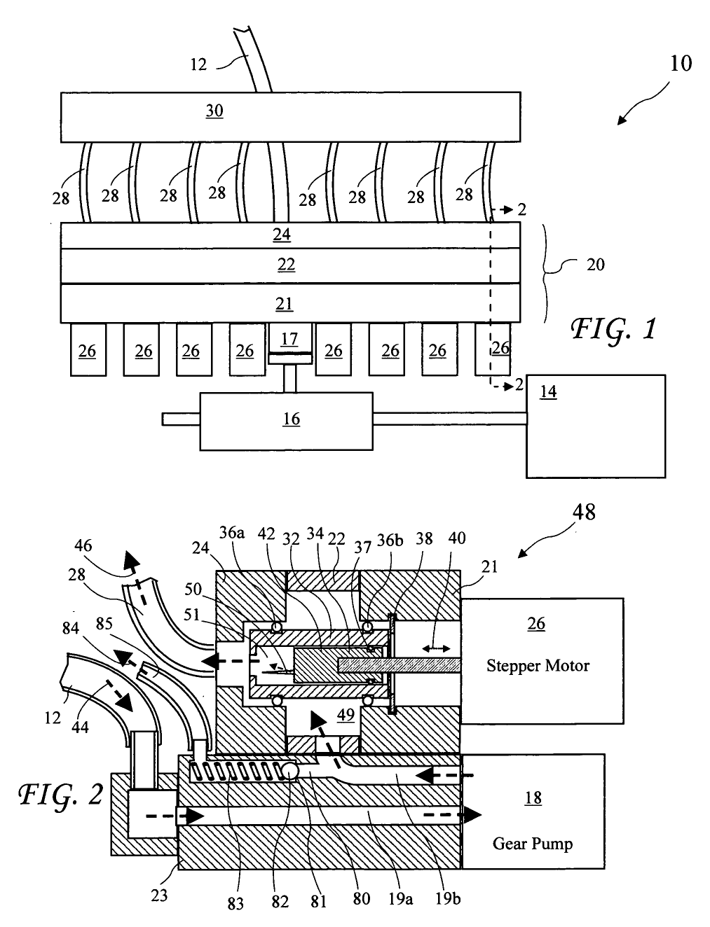

A digital newspaper press inker assembly 10 according to the present invention is shown in FIG. 1. The digital newspaper press inker assembly 10 includes a first ink line 12 providing a flow of ink into the digital newspaper press inker assembly 10, an inker assembly housing 20, a pump motor 14, a 90 degree gear box 16, a gear drive 17, linear stepper motors 26, second ink lines 28, and an ink rail 30. The housing comprising a stepper motor end portion 21, a center portion 22, an ink outlet end portion 24, and a manifold portion 23. The motor 14 is connected to the pumps 18 (see FIG. 2) through a gear box 16 and gear drive 17. The stepper motors 26 control valves residing in the housing 20 to control a flow of ink to the ink rail 30. While a stepper motor is preferred, an inker assembly with another type of electrical linear actuator is intended to come within the scope of the present invention. An example of a suitable linear actuator is 35000 Series Size 14 Linear Actuator made by Haydon Switch and Instrument in Waterbury Conn.

A cross-sectional view of one valve assembly 48 according to the present invention of the digital newspaper press inker assembly 10 is shown in FIG. 2. Each assembly 48 includes a valve cylinder 32 with an orifice 50, and a valve piston 34 residing in a cylinder interior 51 of the valve cylinder 32. First O-rings 36a and 36b from a seal between the cylinder 32 and the housing 20, and a second O-ring 37 forms a seal between the piston 34 and the cylinder 32. An ink inflow 44 enters the manifold 23 through the line 12 and passes through a low pressure side passage 19a in the manifold 23 to the pump 18, back through a high pressure side passage 19b in the manifold 23 and into a housing interior 49 of the housing 20, through the orifice 50 to the cylinder interior 51 of the cylinder 32, and from the cylinder interior 51 to a line 46 as a controlled outflow 46. Each valve assembly 48 preferably includes it's own gear pump 18, and all of the gear pumps 18 are preferably driven from the gear drive 17 (see FIG. 1).

The position of the piston 34 within the cylinder 32 is controlled by the stepper motor 26 to adjust amount of the orifice 50 covered by the piston 34 to regulate the flow of ink through the valve assembly 48. The orifice 50 is precisely tapered so that a linear relationship exists between the piston position and the flow of ink. A non-tapered orifice would result in a non-linear relationship because as the piston 34 is moved to uncover more of the orifice 50 and produce a higher flow rate, pressure within the housing 20 would drop, and the flow of ink would not increase proportionally to piston position. The orifice is thus tapered to compensate for pressure drop as the flow rate increases.

The manifold 23 includes a pressure control system for regulating pressure of the flow of ink to the housing interior 49 to provide uniform control of the flow of ink through the valve. The pressure control system preferably comprises a bypass passage 80 intersecting the high pressure side passage 19b between the pump 18 and the housing interior 49. A ball 82 is biased against a seat 81 in the bypass passage 80 by a spring 83 to seal the bypass passage 80. The spring 83 is selected to allow the ball 82 to back away from the seat 81 resulting in a bleed-off flow 84 through bleed-off line 85 to return the ink to a reservoir thereby regulating the pressure in the high pressure side passage 19b.

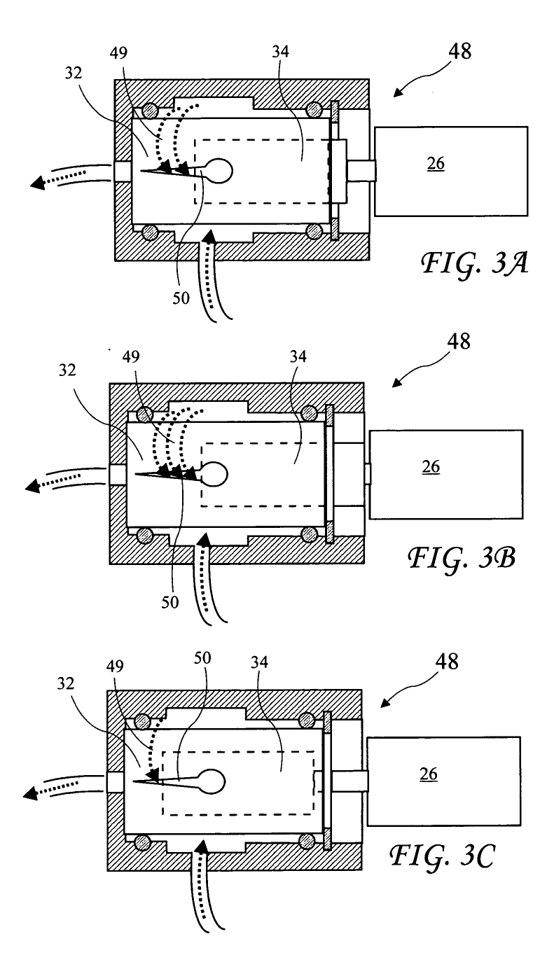

A cutaway view of the valve assembly 48 is shown in a partially open state in FIG. 3A, in a fully open state in FIG. 3B, and in a nearly closed state in FIG. 3C, thus showing the affect of piston 34 position in the cylinder 32.

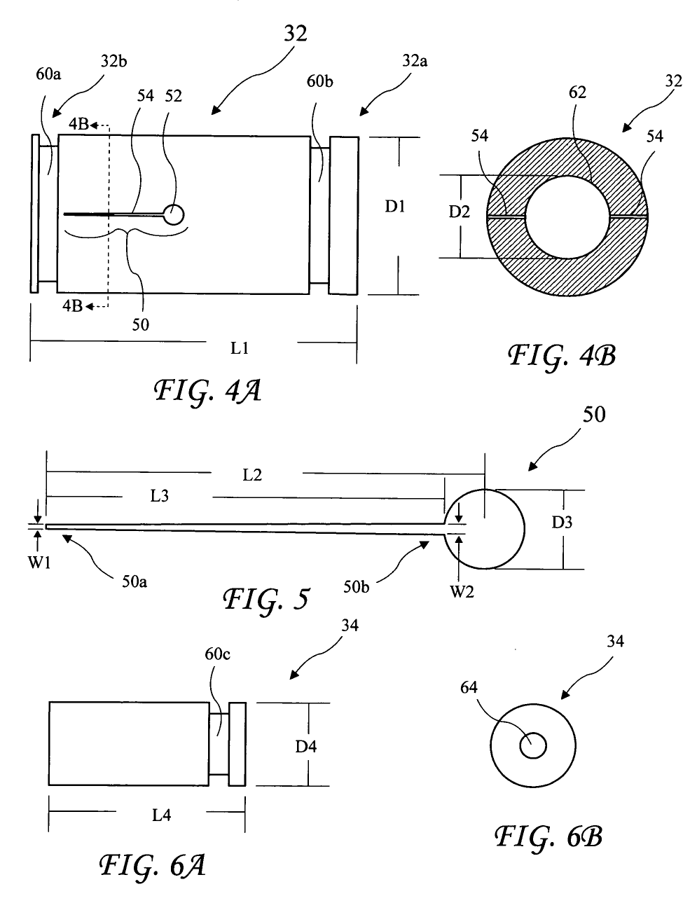

A detailed side view of the valve cylinder 32 according to the present invention is shown in FIG. 4A, and a cross-sectional view of the valve cylinder 23 taken along line 4B-4B of FIG. 4A is shown in FIG. 4B. The cylinder 32 has two o-ring grooves 60a and 60b for the o-rings 36a and 36b (see FIG. 2). The cylinder has a cylinder length L1, cylinder outside diameter D1, and cylinder inside diameter D2. The length L1 is preferably approximately 1.533 inches, the diameter D1 is preferably approximately 0.7491 inches, and the diameter D2 is preferably between approximately 0.3953 inches and approximately 0.3954 inches. The two tapered orifices 50 residing in opposite sides of the cylinder 32 includes a precision tapered portions 54 and round openings 52 at a wide end 50b (see FIG. 5) of the orifice. The piston 34 enters the cylinder 32 through a first cylinder end 32a and the tapered orifice 50 resides towards a second cylinder end 32b with a narrow end 50a of the tapered orifice pointed toward the second end 32b.

A detailed view of the tapered orifice 50 according to the present invention is shown in FIG. 5. The orifice narrow end 50a has a width W1 and the wide end 50b has a width W1. The length of the tapered portion 54 (measured from the narrow end 50a to the center of the round portion 52) is L2, and the diameter of the round portion 52 is D3. The length L3 from the narrow end 50a to the wide end 50b is L3. The width W1 is preferably between approximately 0.0045 inches and approximately 0.0055 inches and is more preferably approximately 0.0050 inches. The width W2 is preferably between approximately 0.0135 inches and approximately 0.0145 inches and is more preferably approximately 0.0140 inches. The length L2 is preferably approximately 0.515 inches, the length L3 is preferably approximately 0.468 inches, and the diameter D3 is preferably approximately 0.094 inches. Although one orifice 50 is shown in FIG. 4A, the dimensions described above apply to a cylinder 32 having a second orifice 50 of the same dimensions residing on an opposite side of the cylinder 32.

The preferred dimensions for the tapered orifice 50 were developed for a pump 18 supplying approximately 140 grams of ink per minute at a pressure of approximately 40 PSI to each valve assembly 48. The ink flow of approximately 140 grams of ink per minute at a pressure of approximately 40 PSI is the maximum flow targeted for each printing press inker assembly 48 to be able to supply to the printing press. To obtain a greater maximum ink flow from the same pump, the tapered orifice 50 dimensions may be increased. To obtain a lessor maximum ink flow from the same pump, the tapered orifice 50 dimensions may be decreased. Regardless of a requirement for more or less ink flow, the tapered orifice 50 is designed to start out narrow and linearly increase in width to compensate for a pressure drop as the valve is opened (i.e., piston moved), to produce a flow linear with the piston 34 position. The maximum flow of ink flow thru the valve assembly 48 may also be changed by increasing or reducing the ink supply pressure. The pumps 18 are preferably common gear pumps used in known printing press inker assemblies and may comprise a separate pump for each valve assembly 48 or a single pump with the pump output distributed to the valve assembly 48, or some arrangement of more than one pump and a distribution manifold for the pumps.

The round portion 52 of the orifice 50 is initially drilled to allow Electrical Discharge Machining (EDM) wire to be fed into the cylinder 32 to cut the precision tapered portion 54 of the orifice 50. Additionally, the circular opening provides a large flow area for purging ink from the valve.

A side view of a valve piston 34 according to the present invention is shown in FIG. 6A and an end view of the valve piston 34 is shown in FIG. 6B. The piston 34 includes an o-ring groove 60c for the o-ring 37 (see FIG. 2). The piston 34 has a piston length L4, a piston outside diameter D4, and a stepper motor shaft mouth 64. The length L4 is preferably approximately 0.923 inches and the diameter D4 is preferably approximately 0.395 inches. The mouth 64 preferably accepts a threaded stepper motor shaft and is more preferably a M3 by 0.5 by 0.35 threaded mouth.

Other sized cylinder interior diameters D2 and piston diameters D4 may be used, and preferably the diameter D2 is between approximately 0.0003 inches and approximately 0.0004 inches greater than the diameter D4. Further, when other diameters are used, the thickness between the outside cylinder diameter D1 and the inside cylinder diameter D2 is preferably approximately 0.1769 inches.

While preferred dimensions and components have been described herein, various combinations of orifice width and length, cylinder inside diameter and piston outside diameter, pump, and actuator may be used to provide a linear flow rate with piston position. Therefore, while the orifice dimensions provided herein are suitable for the pump and linear actuator described therein, other orifices may be empirically determined for other pumps and actuators, and any valve assembly having a tapered orifice providing such linear relationship is intended to come within the scope of the present invention.

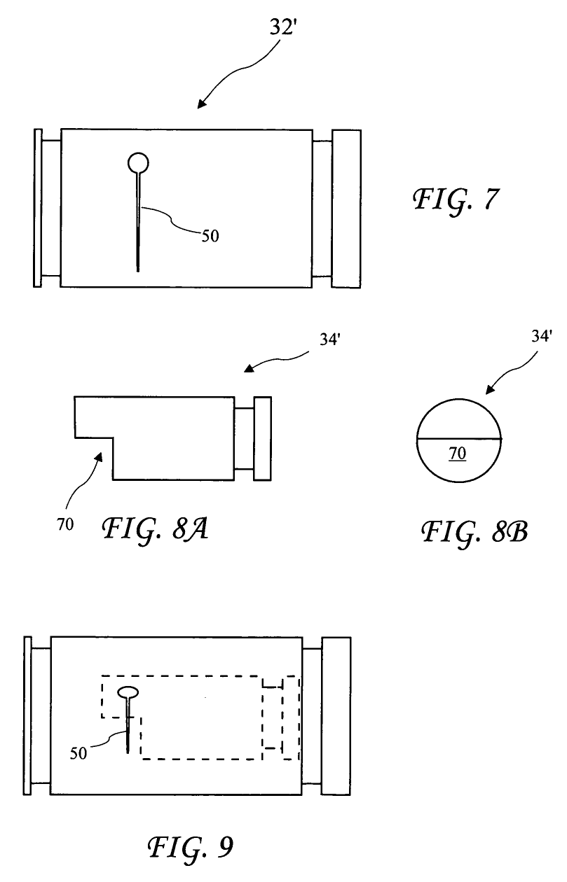

A second valve cylinder 32′ for a rotationally actuated piston 34′ is shown in FIG. 7, a side view of the rotationally actuated piston 34′ is shown in FIG. 8A, an end view of the rotationally actuated piston 34′ is shown in FIG. 8B, and a view of the piston 34′ (drawn in phantom lines) in the cylinder 32′ is shown in FIG. 9. The cylinder 32′ includes an angularly extending tapered orifice 50 and the piston 34′ includes a cutout portion 70 for cooperation with the angularly extending tapered orifice 50. Thus, angular actuation, for example by an angular stepper motor, results in the piston 34′ overlapping more or less of the angularly extending tapered orifice 50 and thereby regulating the outflow 46 of the valve assembly.

While the invention herein disclosed has been described by means of specific embodiments and applications thereof, numerous modifications and variations could be made thereto by those skilled in the art without departing from the scope of the invention set forth in the claims.

I claim:

1. A printing press inker assembly comprising:
a pump;
a first ink line providing ink to the pump;
a housing interior of the inker assembly, the housing interior receiving the ink from the pump;
a cylinder residing in the housing interior, the cylinder having a cylinder interior, a first cylinder end, and a second cylinder end opposite the first cylinder end, the cylinder interior in fluid communication with a second ink line; at least one tapered orifice in the cylinder providing fluid communication between the housing interior and the cylinder interior;
a piston slidably residing in the cylinder interior and actuable through the first cylinder end, the piston slidable to adjust an overlap of the piston with the at least one tapered orifice to regulate a flow through the orifice from the housing interior into the cylinder interior to provide a regulated outflow.

2. The printing press inker assembly of claim 1, further including an electrical linear actuator for actuating the piston, wherein:
a narrow end of the orifice resides toward the second cylinder end; and
the piston is longitudinally slidable to adjust the overlap of the piston with the tapered orifice.

3. The printing press inker assembly of claim 2 wherein the electrical linear actuator is a stepper motor.

4. The printing press inker assembly of claim 2 wherein the cylinder includes two tapered orifices having:
the narrow end having a width W1 between approximately 0.0045 inches and approximately 0.0055 inches;
a wide end having a width W2 between approximately 0.0135 inches and approximately 0.0145 inches; and
a length L3 measured from the narrow end to the wide end of approximately 0.468 inches.

5. The printing press inker assembly of claim 4, wherein each tapered orifice include a round portion at the wide end, the round portion having a diameter D3 of approximately 0.094 inches.

6. The printing press inker assembly of claim 4, wherein the cylinder has an inside diameter D2 and the piston has an outside diameter D4, and the diameter D2 is between approximately 0.3953 inches and approximately 0.3954 inches and the diameter D4 is approximately 0.395 inches.

7. The printing press inker assembly of claim 4, wherein the cylinder has an inside diameter D2 and the piston has an outside diameter D4, and the diameter D2 is between approximately 0.0003 inches and approximately 0.0004 inches greater than the diameter D4.

8. The printing press inker assembly of claim 4, wherein the width W1 is approximately 0.0050 inches and the width W2 is approximately 0.0140 inches.

9. The printing press inker assembly of claim 2, wherein the tapered orifice is shaped and sized to provide a regulated outflow linearly related to the position of the piston in the cylinder interior.

10. The printing press inker assembly of claim 1, wherein:
the piston is rotationally actuated to regulate the outflow;
the piston includes a cutout portion; and
the orifice extends angularly in the valve body wall, wherein rotation of the piston results in a varying amount of the cutout portion overlapping the orifice, thereby regulating the outflow.

11. The printing press inker assembly of claim 1, further including a pressure regulator for regulating an ink flow from the pump to the housing interior.

12. A printing press inker assembly comprising:
a pump;
a low pressure side passage providing fluid communication between a first ink line and a low pressure side of the pump;
a high pressure side passage in fluid communication with a high pressure side of the pump;
an inker assembly housing having a housing interior, the housing interior in fluid communication with the pump through the high pressure side passage;
a cylinder residing in the housing interior, the cylinder having a cylinder interior, a first cylinder end, and a second cylinder end opposite the first cylinder end, the cylinder interior in fluid communication with a second ink line; at least one tapered orifice providing fluid communication between the housing interior and the cylinder interior, the at least one orifice having a narrow end pointed toward the second cylinder end;
a piston slidably residing in the cylinder interior and linearly actuable through the first cylinder end, the piston slidable to adjust an overlap of the piston with the tapered orifice to regulate a flow through the orifice into the cylinder interior to provide a regulated outflow linear with the overlap of the piston with the orifice.

13. The printing press inker assembly of claim 12, wherein at least one tapered orifice comprises two tapered orifices on opposite sides of the cylinder.

14. A printing press inker assembly comprising:
a pump having a low pressure side and a high pressure side;
a low pressure side passage providing fluid communication between a first ink line and the low pressure side of the pump;
a high pressure side passage in fluid communication with the high pressure side of the pump;
an inker assembly housing having a housing interior, the housing interior in fluid communication with the pump through the high pressure side passage;
a pressure regulator in fluid communication with the high pressure side passage for regulating an ink flow from the pump to the housing interior.
a cylinder residing in the housing interior, the cylinder having a cylinder interior, a first cylinder end, and a second cylinder end opposite the first cylinder end, the cylinder interior in fluid communication with a second ink line through the second cylinder end;
two tapered orifices providing fluid communication between the housing interior and the cylinder interior, the orifices having a narrow end pointed toward the second cylinder end;
a piston slidably residing in the cylinder interior and linearly actuable through the first cylinder end, the piston slidable to adjust an overlap of the piston with the tapered orifices to regulate a flow through the orifices into the cylinder interior to provide a regulated outflow through the second ink line, which regulated out flow is linear with the overlap of the piston with the orifices; and
a stepper motor for actuating the piston through the first cylinder end.
